(19) United States
(12) Patent Application Publication
(10) Pub. No.: US 2009/0249965 A1
(43) Pub. Date: Oct. 8, 2009

(54) PIT REMOVER

(75) Inventor: Lawrence M. Hauser, Auburn, WA (US)

Correspondence Address: BLACK LOWE & GRAHAM, PLLC, 701 FIFTH AVENUE, SUITE 4800, SEATTLE, WA, 98104, US

(73) Assignee: PROGRESSIVE INTERNATIONAL CORPORATION, Kent, WA (US)

(21) Appl. No.: 12/417,543

(22) Filed: Apr. 2, 2009

Related U.S. Application Data
(60) Provisional application No. 61/041,860, filed on Apr. 2, 2008.

(51) Int. Cl. A23N 4/22

(52) U.S. Cl. 99/552; 99/547

(57) ABSTRACT

The preferred example of the pit remover and slicer includes a frame having a central hub and one or more blades extending radially from the central hub to the frame. In some versions, the pit remover may include a frame defining an interior region, with one or more blades extending across the interior space, either with or without a defined central hub.

### PRIORITY CLAIM

This application claims the benefit of U.S. Provisional Application Ser. No. 61/041,860 filed Apr. 2, 2008 contents of which are hereby incorporated by reference.

### FIELD OF THE INVENTION

This invention relates generally to devices for pitting and slicing fruits.

### BACKGROUND OF THE INVENTION

There are devices on the market that core and slice fruits such as apples. One common device includes a round frame that supports six blades radiating from an inner circular blade that is sized to remove the core of the apple. The size of the central hub blade may not readily adapt to removing the pit from a stone fruit such as peaches, nectarines, and apricots, and the six blades likewise are undesirable in many instances.

### SUMMARY OF THE INVENTION

The preferred example of the pit remover and slicer includes a frame having a central hub and one or more blades extending radially from the central hub to the frame. In some versions, the pit remover may include a frame defining an interior region, with one or more blades extending across the interior space, either with or without a defined central hub.

In preferred examples of the invention, the frame is comprised of two or more components, each of which having at least one blade. The two or more frame components are rotationally slideable with respect to one another, thereby also providing internal blades that are rotatable with respect to one another. The rotating movement allows for a reconfigurable blade arrangement, allowing a fruit or vegetable to be sliced into different shaped wedges or other shapes.

In yet other versions, the frame is formed as a single unitary component while the blades are secured to the frame in a fashion that allows the blades to be moved with respect to the frame, thereby allowing for different blade configurations within the frame.

### BRIEF DESCRIPTION OF THE DRAWINGS

FIG. 1 is top perspective view of a preferred pit remover;

FIG. 2 is a top view of a preferred pit remover;

FIG. 3 is a perspective view of the pit remover shown in FIG. 1, with the blades repositioned;

FIG. 4 is an exploded view of a preferred pit remover;

FIG. 5 is a perspective view of a frame portion for a preferred pit remover; and

FIG. 6 is a front view of a frame for a preferred pit remover.

### DETAILED DESCRIPTION OF THE PREFERRED EMBODIMENT

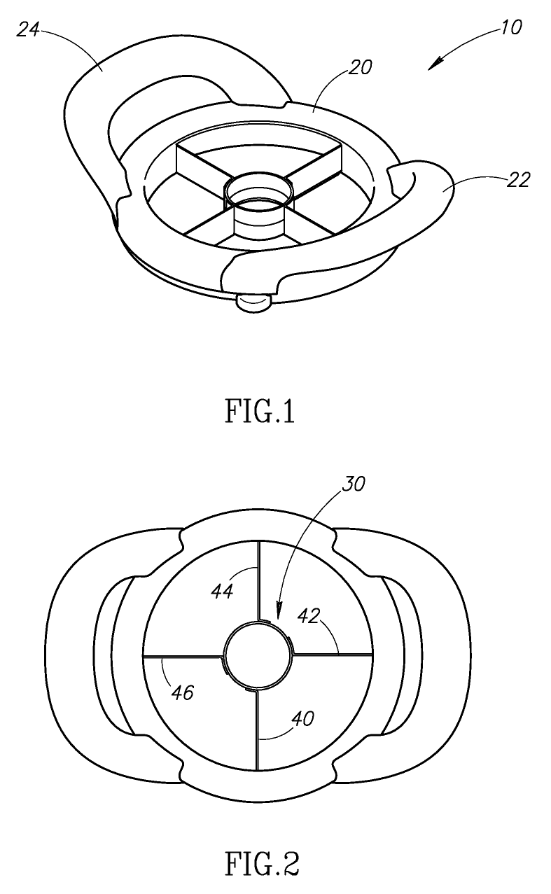

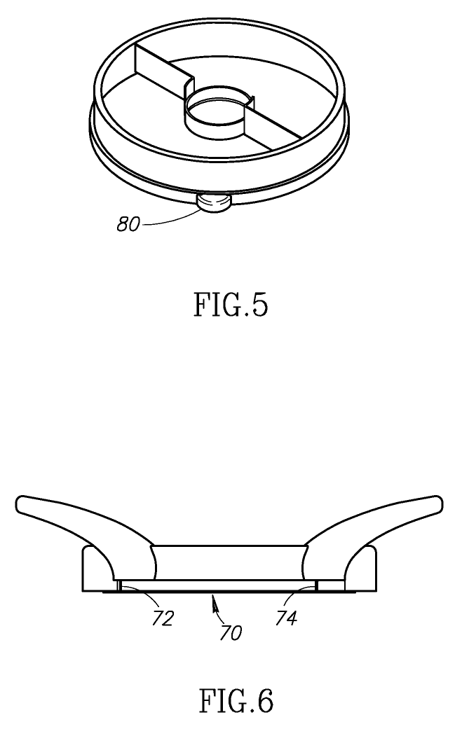

A preferred pit remover and slicer 10 is shown in FIGS. 1-6. In FIG. 1, a fully assembled device is shown in perspective view. As configured in FIG. 1, the pit remover and slicer includes an annular frame 20 having a pair of handles 22, 24. Each of the handles is provided on opposing sides of the frame, and each extends upward and radially outward from the frame. Though configured in the illustrated embodiment as having an annular frame, in other versions of the invention the frame may be square, rectangular, or have other shapes other than annular. Likewise, the handles need not extend upward and radially outward from the frame, but rather may be generally planar with the frame or may take the form of a peripheral flange extending uniformly about the circumference of the frame. For that matter, in some versions the handles may be omitted altogether.

Within the frame the device includes a circular central hub blade 30 and four substantially straight slicing blades 40, 42, 44, 46, with each of the slicing blades extending radially from the central hub toward the frame. In a preferred example, the frame and handles are formed from ABS or other plastic while the blades are formed from stainless steel. Other materials such as ceramic, wood, or other metals may also be used.

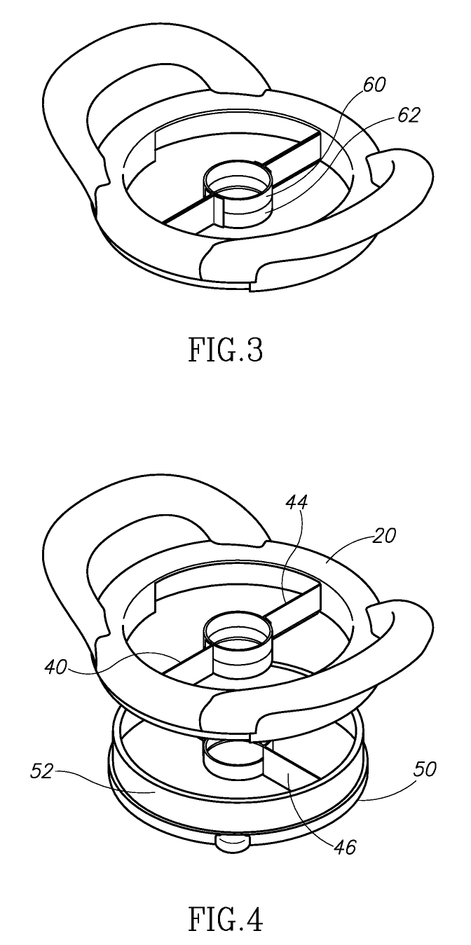

As best seen in the exploded view of FIG. 4, the central hub and slicing blades are made so that they are reconfigurable in several different positions. Thus, in FIG. 1 the device is configured so that the slicing blades will cut a fruit into quarters, while in FIG. 3 the device is configured to cut a fruit into halves. In other configurations the device may cut the fruit into different-shaped wedges or a different number of wedges. Likewise, as discussed further below, additional blades may be incorporated in order to cut the fruit into a greater number of wedges or pieces.

As best seen in FIGS. 4-6, the preferred example of the invention includes a primary frame portion 20 and at least one blade that is secured to the frame 20 for rotational movement with respect to the frame. In the version as shown, the rotatable blade is mounted within an annular frame member 50 that is configured to be received by the primary frame portion 20 for sliding and rotational movement within the primary frame portion. The primary frame portion likewise includes a blade fixedly mounted to the frame and extending diametrically across the interior region defined by the frame, though in alternate versions of the invention the frame may have no blades that are fixedly mounted to the frame.

The primary frame 20 includes a central channel that mates with an upwardly extending flange 52 on the blade frame 50. The blade frame may further include an upper lip or other extension on the flange 52 that engages a well within the central channel in the primary frame 20, thereby allowing the blade frame 50 to be snap-fit into the receiving channel of the primary frame to hold it in place. Once in place, the primary frame portions are rotatable with respect to one another and about a common central pivot point. Although the preferred version includes a channel and upwardly extending flange, the device may be formed in different ways in order to accomplish the ability of the blades to pivot with respect to one another.

In the preferred version, the blades extend diametrically across the primary frame and the one or more additional blade frames, and includes a central ring forming a hub 60, 62 at a location substantially at the center of the interior region defined by the frame. Each of the slicing blades 40, 42, 44, 46 includes a height from the top to the sharpened bottom edge of the blade. The central hub 60 of the primary frame also includes a height from the top of the hub to the bottom of the hub, with the height preferably being approximately half that of the slicing blades. In the example as shown, the blades are formed in three portions, including a first blade portion, a second blade portion, and the central hub. Each of the first blade portion and the second blade portion terminates adjacent the central hub in a bend forming an arc that is adjacent to a portion of the perimeter of the central hub. The stainless steel first and second blade portions are welded or otherwise affixed to the hub such that the hub is substantially flush with the top of the blades and terminates between the top and bottom of the blades.

The lower blade frame member similarly includes a pair of radiating slicing blades that include a height from the top to the sharpened bottom edge of the blade. The lower central hub portion 62 of the blade frame member includes a height that is about half that of the height of the blades. The stainless steel blades are formed in substantially the same manner as the blades described above with respect to the primary frame, and are welded or otherwise affixed to the hub portion 62 such that the lower hub portion is substantially flush with the bottom of the blades and terminates between the top and bottom of the blades. In the case of the lower hub member, the lower edge may be sharpened to facilitate cutting.

When the upper and lower frame members are brought together, the upper and lower hub portions are adjacent one another and combine to form a height that is approximately the same as the height of the blades. The upper hub portion 60 of the primary frame overlies the lower hub portion 62 of the blade frame, are the both substantially the same size and shape, such that they will follow the same path in use to slice or core a fruit.

An outer edge of the upper frame includes a slot or cutout region 70 as best seen in the front view of FIG. 6. The slot defines an arc of about ninety degrees about the perimeter of the annular frame and terminates in edges 72, 74 at either side of the cutout. The slot is configured to receive a tab 80 extending radially from an outer edge of the lower frame member such that the tab slides within the slot. The tab includes a well that is sized to snugly receive a corresponding edge of the slot.

In use, the user may rotate the primary frame portion with respect to the blade frame as the flange slides within the channel and the tab 80 slides within the slot 70. The tab and edges serve of the slot as stops that limit the path of rotational travel of the blade frame with respect to the primary frame portion. Likewise, the snug fit of the edge of the slot within the well of the tab holds the two frame halves in position with respect to one another at either one of the two edges. While the tab and slot configuration is a preferred form of defining and limiting the path of travel, other constructions are also possible in different versions.

When the two frame halves are rotated such that the tab is adjacent a first edge 74, the blades are positioned as in FIG. 1 in which a fruit will be cut into quarters. When the two frame halves are repositioned such that the tab is adjacent the second edge 72, the blades are positioned as in FIG. 3 in which the fruit will be cut in halves. This latter configuration is especially useful for stone fruits in that the device can remove the stone while slicing the fruit in half.

In other versions of the invention, the cutout may define a different arc or arcs, thereby allowing for yet other blade configurations. Likewise, in another version of the invention a third annular blade frame and corresponding pair of blades is provided. In such an alternate version, the three pairs of blades are rotatable with respect to one another such that the fruit may be cut into halves, quarters, or sixths depending on whether the blades lie atop one another or are equally spaced apart. Additional sets of blades and frame members may further be included in a like manner.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

I claim:

1. A pit remover, comprising:
a primary frame defining an interior space within the primary frame;
a first blade attached to the primary frame and extending into the interior space; and
a blade frame secured to the primary frame for rotational movement with respect to the primary frame, the blade frame further having a second blade attached to the blade frame, whereby rotational movement of the blade frame with respect to the primary frame causes corresponding rotational movement of the first blade with respect to the second blade.

2. The pit remover of claim 1, wherein the first blade is fixedly secured to the primary frame.

3. The pit remover of claim 2, wherein the first blade comprises a first blade portion, a second blade portion, and a first central hub, the first central hub being shaped as a ring, each of the first blade portion and the second blade portion lying in a common diameter across the primary frame, the first blade portion and the second blade portion each having a first end secured to the primary frame and a second end secured to first central hub.

4. The pit remover of claim 3, wherein the second blade comprises a first blade portion, a second blade portion, and a second central hub, the second central hub being shaped as a ring, each of the first blade portion and the second blade portion lying in a common diameter across the blade frame, the first blade portion and the second blade portion each having a first end secured to the blade frame and a second end secured to second central hub.

5. The pit remover of claim 4, wherein the first central hub and the second central hub overlie one another.

6. The pit remover of claim 5, wherein the primary frame is formed as an annular frame and further comprises an annular channel and the blade frame further comprises an annular flange, the annular flange being received within the annular channel to secure the blade frame to the primary frame for rotational movement.

7. The pit remover of claim 5, wherein the primary frame further comprises a peripheral slot formed in a portion of the primary frame, the peripheral slot having a first edge and a second edge, and further wherein the blade frame comprises a tab extending radially outward from the blade frame, the tab being received within the slot for sliding movement between the first edge and the second edge.

8. The pit remover of claim 7, wherein the tab further comprises a well, the well being configured to snugly receive one of the first edge or the second edge.

9. The pit remover of claim 7, wherein the peripheral slot forms an arc of approximately 90 degrees.

10. The pit remover of claim 9, wherein the first blade and second blade are positioned within the primary frame and the blade frame, respectively, such that when the tab is adjacent the first edge the first blade is oriented at approximately ninety degrees with respect to the second blade, and when the tab is adjacent the second edge the first blade is substantially parallel to the second blade.

11. A pit remover, comprising:
an annular frame defining an interior space within the primary frame;
a first blade attached to opposing sides of the primary frame and extending substantially diametrically across the interior space; and
a second blade connected to the pit remover for rotational movement of the second blade with respect to the first blade, the second blade extending substantially diametrically across the interior space.

12. The pit remover of claim 11, wherein the second blade is connected to an annular blade frame, the annular blade frame being secured to the annular frame for sliding rotational movement of the annular blade frame with respect to the annular frame.

13. The pit remover of claim 12, wherein each of the first blade and the second blade comprises a first blade portion, a second blade portion, and a circular central hub, each of the first blade portions and the second blade portions being connected to opposing sides of one of the central hubs and extending radially outward from the central hub.

14. The pit remover of claim 13, further comprising a projection on one of the annular frame or the annular blade frame and a channel on the other of the annular frame or the annular blade frame, the projection being received within the channel such that the channel defines a limited path of travel within which the projection may travel, whereby the annular frame and the annular blade frame may rotate with respect to one another within the limited path of travel.

15. The pit remover of claim 14, wherein the channel further comprises a first edge and a second edge, the first and second edges defining a first endpoint and a second endpoint, whereby the limited path of travel is defined by the first endpoint and the second endpoint.

16. The pit remover of claim 15, wherein the first blade and second blade are positioned within the annular frame and the annular blade frame, respectively, such that when the projection is adjacent the first edge the first blade is oriented at approximately ninety degrees with respect to the second blade, and when the projection is adjacent the second edge the first blade is substantially parallel to the second blade.

17. The pit remover of claim 15, wherein the first blade and second blade are positioned within the annular frame and the annular blade frame, respectively, such that when the projection is adjacent the first edge the first blade and the second blade divide the interior space into four quarters, and when the projection is adjacent the second edge the first blade and the second blade divide the interior space into two substantially equal halves.
